(19) United States
(12) Patent Application Publication
(10) Pub. No.: US 2014/0071586 A1
(43) Pub. Date: Mar. 13, 2014

(54) MULTILAYER CERAMIC ELECTRONIC COMPONENT AND METHOD OF MANUFACTURING THE SAME

(71) Applicant: SAMSUNG ELECTRO-MECHANICS CO., LTD., Suwon (KR)

(72) Inventors: Jae Sung PARK, Suwon (KR); Jae Hyuk SHIM, Suwon (KR); Byung Kwon YOON, Suwon (KR); Sang Huk KIM, Suwon (KR)

(73) Assignee: SAMSUNG ELECTRO-MECHANICS CO., LTD., Suwon (KR)

(21) Appl. No.: 13/839,836

(22) Filed: Mar. 15, 2013

(30) Foreign Application Priority Data
Sep. 10, 2012 (KR) 10-2012-0099993

(51) Int. Cl. H01G 4/30

(52) U.S. Cl. CPC H01G 4/30
USPC 361/301.4; 156/60

(57) ABSTRACT

There is provided a multilayer ceramic electronic component, including: a ceramic body including a dielectric layer; first and second internal electrodes disposed to face each other with the dielectric layer interposed therebetween within the ceramic body; and first and second external electrodes formed on external surfaces of the ceramic body and electrically connected to the first and second internal electrodes, wherein, when the dielectric layer is divided into three areas in a thickness direction of the ceramic body, an average size of dielectric grains in a middle area is different from that of dielectric grains in upper and lower areas, and when T1 denotes a thickness of the dielectric layer, T2 denotes a thickness of the middle area, and T3 and T4 denote thicknesses of the upper and lower areas adjacent to the first and second internal electrodes, T2≧0.45T1 and T3+T4≦0.55T1 are satisfied.

### CROSS-REFERENCE TO RELATED APPLICATIONS

This application claims the priority of Korean Patent Application No. 10-2012-0099993 filed on Sep. 10, 2012, in the Korean Intellectual Property Office, the disclosure of which is incorporated herein by reference.

### BACKGROUND OF THE INVENTION

1. Field of the Invention

The present invention relates to a high capacitance multilayer ceramic electronic component capable of improving withstand voltage characteristics and having excellent reliability.

2. Description of the Related Art

In accordance with the recent trend for the miniaturization of electronic products, multilayer ceramic electronic components have also been required to be compact and have high capacitance.

Therefore, a dielectric layer and an internal electrode layer have been thinned and laminated in increasing amounts by various methods. Recently, as the dielectric layer has been thinned, multilayer ceramic electronic components having increased numbers of laminated layers included therein have been manufactured.

As the dielectric layer and the internal electrode layer have been thinned in order to realize high capacitance, the internal electrode layer may be neither uniformly thin nor continuous, and thus, the internal electrode layer may be partially discontinuous, thereby deteriorating the continuity thereof.

When the thickness of the internal electrode layer is not uniform, thick portions of the internal electrode layers may be adjacent to each other with the dielectric layer therebetween, resulting in a deteriorated breakdown voltage (BDV) characteristics.

The above problem may degrade insulating properties, and thus deteriorate reliability of the multilayer ceramic electronic component.

### RELATED ART DOCUMENT

(Patent Document 1) Japanese Laid-Open Patent Publication No. 2003-264120

### SUMMARY OF THE INVENTION

An aspect of the present invention provides a high capacitance multilayer ceramic electronic component having improved withstand voltage characteristics and excellent reliability.

According to an aspect of the present invention, there is provided a multilayer ceramic electronic component, including: a ceramic body including a dielectric layer; first and second internal electrodes disposed to face each other with the dielectric layer interposed therebetween within the ceramic body; and first and second external electrodes formed on external surfaces of the ceramic body and electrically connected to the first and second internal electrodes, wherein, when the dielectric layer is divided into three areas in a thickness direction of the ceramic body, an average size of dielectric grains in a middle area of the three areas is different from that of dielectric grains in upper and lower areas thereof, and when T1 denotes a thickness of the dielectric layer, T2 denotes a thickness of the middle area, and T3 and T4 denote thicknesses of the upper and lower areas adjacent to the first and second internal electrodes, T2≧0.45T1 and T3+T4≦0.55T1 are satisfied.

When the average size of the dielectric grains in the middle area is denoted by G1 and the average size of the dielectric grains in the upper and lower areas is denoted by G2, G1≧1.5×G2 may be satisfied.

The dielectric layer may have an average thickness of 0.6 μm or less.

The first and second internal electrodes may have an average thickness of 0.6 μm or less.

The first and second internal electrodes may include at least one selected from the group consisting of nickel (Ni), copper (Cu), palladium (Pd), and a palladium-silver (Pd—Ag) alloy.

According to another aspect of the present invention, there is provided a method of manufacturing a multilayer ceramic electronic component, the method including: preparing ceramic green sheets by using a slurry containing a ceramic powder; forming internal electrode patterns on the ceramic green sheets by using a conductive metal paste; forming a ceramic body including a dielectric layer by laminating the ceramic green sheets; and forming first and second external electrodes on external surfaces of the ceramic body, the first and second external electrodes being electrically connected to the first and second internal electrodes, wherein, when the dielectric layer is divided into three areas in a thickness direction of the ceramic body, an average size of dielectric grains in a middle area of the three areas is different from that of dielectric grains in upper and lower areas thereof, and when T1 denotes a thickness of the dielectric layer, T2 denotes a thickness of the middle area, and T3 and T4 denote thicknesses of the upper and lower areas adjacent to the first and second internal electrodes, T2≧0.45T1 and T3+T4≦0.55T1 are satisfied.

When the average size of the dielectric grains in the middle area is denoted by G1 and the average size of the dielectric grains in the upper and lower areas is denoted by G2, G1≧1.5×G2 may be satisfied.

The dielectric layer may have an average thickness of 0.6 μm or less.

The first and second internal electrodes may have an average thickness of 0.6 μm or less.

The number of laminated ceramic green sheets may be 400 or more.

The conductive metal paste may include at least one selected from the group consisting of nickel (Ni), copper (Cu), palladium (Pd), and a palladium-silver (Pd—Ag) alloy.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a multilayer ceramic capacitor according to an embodiment of the present invention;

FIG. 2 is a cross-sectional view taken along line B-B′ of FIG. 1;

FIG. 3 is an enlarged view of portion A of FIG. 2; and

FIG. 4 is a view illustrating a process of manufacturing a multilayer ceramic capacitor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

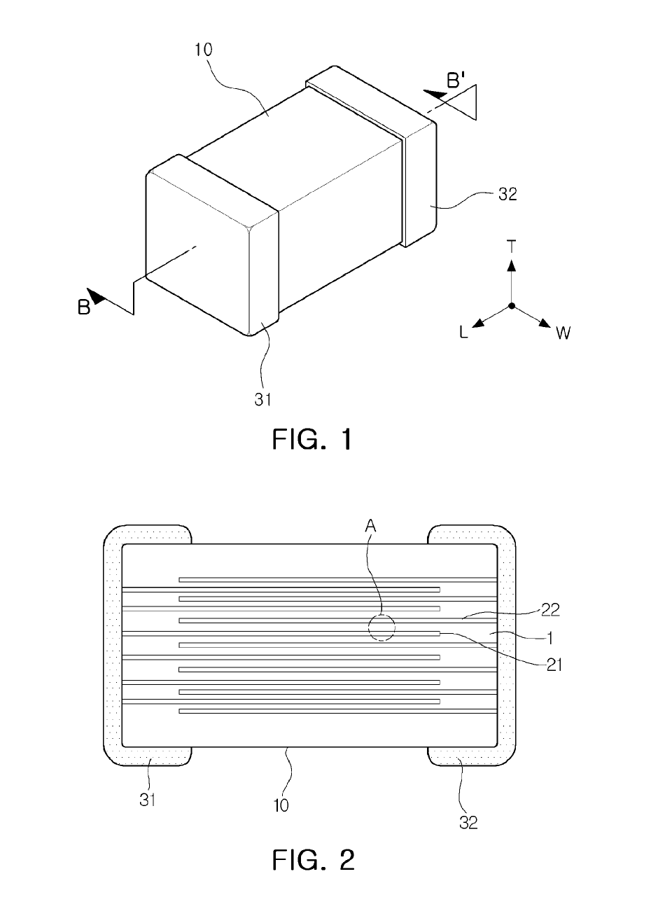

FIG. 1 is a perspective view schematically illustrating a multilayer ceramic capacitor according to an embodiment of the present invention.

FIG. 2 is a cross-sectional view taken along line B-B′ of FIG. 1.

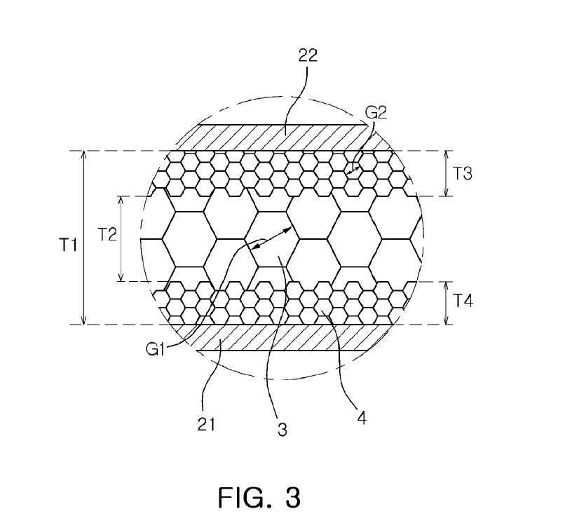

FIG. 3 is an enlarged view of portion A of FIG. 2.

Referring to FIGS. 1 to 3, a multilayer ceramic electronic component according to an embodiment of the present invention may include: a ceramic body 10 including a dielectric layer 1; first and second internal electrodes 21 and 22 disposed to face each other with the dielectric layer 1 interposed therebetween within the ceramic body 10; and first and second external electrodes 31 and 32 formed on external surfaces of the ceramic body 10 and electrically connected to the first and second internal electrodes 21 and 22. Here, when the dielectric layer 1 is divided into three areas in a thickness direction of the ceramic body 10, an average size of dielectric grains in a middle area of the three areas may be different from that of dielectric grains in upper and lower areas thereof, and when T1 denotes a thickness of the dielectric layer 1, T2 denotes a thickness of the middle area, and T3 and T4 denote thicknesses of the upper and lower areas adjacent to the first and second internal electrodes 21 and 22, T2≧0.45T1 and T3+T4≦0.55T1 may be satisfied.

Hereinafter, the multilayer ceramic electronic component according to an embodiment of the present invention, in particular, a multilayer ceramic capacitor, will be described, but the present invention is not limited thereto.

The ceramic body 10 may have, but is not particularly limited to, a hexahedral shape, for example.

Meanwhile, with respect to the multilayer ceramic capacitor according to the present embodiment, a ‘length direction’, a ‘width direction’, and a ‘thickness direction’ are denoted by ‘L’, ‘W’, and ‘T’ in FIG. 1, respectively. Here, the ‘thickness direction’ may be a direction in which the dielectric layer and the internal electrodes are laminated, that is, ‘lamination direction’.

A multilayer ceramic electronic component according to an embodiment of the present invention may include: a ceramic body 10 including a dielectric layer 1; first and second internal electrodes 21 and 22 disposed to face each other with the dielectric layer 1 interposed therebetween within the ceramic body 10; and first and second external electrodes 31 and 32 formed on external surfaces of the ceramic body 10 and electrically connected to the first and second internal electrodes 21 and 22.

The first and second internal electrodes 21 and 22 may be formed by using a conductive paste made of at least one of, for example, precious metals, such as palladium (Pd), a palladium-silver (Pd—Ag) alloy, and the like, nickel (Ni), and copper (Cu), but are not particularly limited thereto.

The external electrodes 31 and 32 may be formed on the external surfaces of the ceramic body 10 in order to form capacitance, and may be electrically connected to the first and second internal electrodes 21 and 22.

The external electrodes 31 and 32 may be formed of the same conductive material as the internal electrodes, but are not limited thereto. For example, the external electrodes 31 and 32 may be formed of copper (Cu), silver (Ag), nickel (Ni), or the like.

The external electrodes 31 and 32 may be formed by coating the external surfaces of ceramic body 10 with a conductive paste prepared by adding glass frit to a metal powder, followed by sintering.

According to the embodiment of the present invention, an average thickness of the dielectric layer 1 may be 0.6 μm or less.

In the embodiment of the present invention, the thickness of the dielectric layer 1 may be an average thickness of the dielectric layer 1 disposed between the first and second internal electrodes 21 and 22.

The average thickness of the dielectric layer 1 may be measured from an image obtained by scanning a cross section of the ceramic body 10 in a length direction thereof using a scanning electron microscope (SEM), as shown in FIG. 2.

For example, as shown in FIG. 2, with respect to a dielectric layer extracted from the image obtained by scanning the cross-section of the ceramic body in a length-thickness (L-T) direction, cut in a central portion of the ceramic body 10 in a width (W) direction thereof, using a scanning electron microscope (SEM), the average thickness thereof may be obtained by measuring thicknesses thereof at 30 equidistant points in the length direction thereof, and then averaging the measured thicknesses.

The thicknesses at 30 equidistant points may be measured in a capacitance forming part, referring to an area of the ceramic body 10 in which the first and second internal electrodes 21 and 22 overlap each other.

In addition, when this measurement for obtaining the average thickness is extensively performed on ten or more dielectric layers and an average measurement value is calculated, the average thickness of the dielectric layer may be further generalized.

Generally, as a multilayer ceramic capacitor has larger capacitance, the dielectric layers therein gradually become thinner.

In this case, when ceramic green sheets are molded and internal electrodes are coated thereon and then they are laminated and sintered, the dielectric layers and the internal electrodes are not attached to each other in parallel, but the internal electrodes may be bent in some areas due to surface roughness of the dielectric layers and the internal electrodes.

Due to such a bending of the internal electrodes, the thinnest area may be present in a single dielectric layer.

The possibility of the occurrence of dielectric breakdown in the thinnest area of the dielectric layer is high.

According to the embodiment of the present invention, in order to solve the foregoing problems, when the dielectric layer 1 is divided into three areas in the thickness direction of the ceramic body 10, an average size of dielectric grains in a middle area of the three areas may be different from that of dielectric grains in upper and lower areas thereof, and when T1 denotes a thickness of the dielectric layer 1, T2 denotes a thickness of the middle area, and T3 and T4 denote thicknesses of the upper and lower areas adjacent to the first and second internal electrodes 21 and 22, T2≧0.45T1 and T3+T4≦0.55T1 may be satisfied.

The average sizes of the dielectric grains in the middle area and the upper and lower areas are variably controlled to be different, and thus, the possibility of the occurrence of dielectric breakdown in the thinnest area of the dielectric layer may be lowered.

Specifically, when the average size of the dielectric grains in the middle area is denoted by G1 and the average size of the dielectric grains in the upper and lower areas is denoted by G2, G1≧1.5×G2 may be satisfied.

That is, the average size G1 of the dielectric grains in the middle area is controlled to be 1.5 times or more than the average size G2 of the dielectric grains in the upper and lower areas, and thus, the possibility of the occurrence of dielectric breakdown in the dielectric layer may be lowered.

Ina case in which the average sizes of dielectric grains in areas of a dielectric layer within a general multilayer ceramic capacitor are equal to each other, the number of grains per layer, measured in the thinnest area of the dielectric layer, may be too low, resulting in a high possibility of occurrence of dielectric breakdown.

However, as in the embodiment of the present invention, in the case in which the average size of dielectric grains in the upper and lower areas is smaller than that of dielectric grains in the middle area, the number of grains per layer may be secured even in the thinnest area of the dielectric layer, and thus, dielectric breakdown may not occur.

In the case in which the average size G1 of the dielectric grains in the middle area is 1.5 times or less than the average size G2 of the dielectric grains in the upper and lower areas, the number of grains per layer may not be sufficiently secured in the thinnest area of the dielectric layer, and thus, dielectric breakdown may occur.

The average size of the dielectric grains in each of the areas of the dielectric layer may be measured by analyzing an image of a cross-section of the extracted dielectric layer by using a scanning electron microscope (SEM).

For example, the average size of the dielectric grains in each of the areas of the dielectric layer may be measured by using grain size measurement software supporting an average grain size standard measurement method defined by the American Society for Testing and Materials (ASTM) standard, E112.

Meanwhile, when T1 denotes the thickness of the dielectric layer 1, T2 denotes the thickness of the middle area, and T3 and T4 denote the thicknesses of the upper and lower areas adjacent to the first and second internal electrodes 21 and 22, T2≧0.45T1 and T3+T4≦0.55T1 may be satisfied.

First, the thickness T2 of the middle area may be 0.45 times or greater than the thickness T1 of the dielectric layer 1.

As such, in the case in which the thickness T2 of the middle area is 0.45 times or greater than the thickness T1 of the dielectric layer 1, the multilayer ceramic capacitor may secure high capacitance due to an increase in dielectric constant, caused by the middle area in which dielectric grains having a relatively larger average size are present.

That is, in the case in which the thickness T2 of the middle area is below 0.45 times the thickness T1 of the dielectric layer 1, the multilayer ceramic capacitor may have a reduction in capacitance due to a decrease in dielectric constant, caused by increasing a ratio of the areas in which dielectric grains having a small average size are present to the entirety of the areas.

Meanwhile, in the case in which a ratio of the area in which dielectric grains having a relatively large average size are present to the entirety of the areas is excessively high, the number of dielectric grains per dielectric layer is decreased, and thus grain boundaries serving as barriers against leakage current are reduced, which may cause a deterioration in reliability.

Therefore, the sum of the thicknesses T3 and T4 of the upper and lower areas adjacent to the first and second internal electrodes 21 and 22 may be controlled to be 0.55 times or less than the thickness T1 of the dielectric layer 1.

In this manner, the grain boundaries serving as barriers against leakage current may be sufficiently secured, and thus, the problem of deteriorated reliability can be solved.

In the case in which the sum of the thicknesses T3 and T4 of the upper and lower areas adjacent to the first and second internal electrodes 21 and 22 is more than 0.55 times the thickness T1 of the dielectric layer 1, the area in which dielectric grains having a relatively large average size are present is increased, which may cause a reduction in capacitance due to a decrease in dielectric constant.

According to the embodiment of the present invention, there may be provided a multilayer ceramic capacitor having excellent reliability and high capacitance, by controlling the thickness T2 of the middle area to be 0.45 times or more than the thickness T1 of the dielectric layer 1 and controlling the sum of the thicknesses T3 and T4 of the upper and lower areas adjacent to the first and second internal electrodes 21 and 22 to be 0.55 times or less than the thickness T1 of the dielectric layer 1.

As such, a method for variably controlling the average sizes of the dielectric grains in areas of a single dielectric layer and controlling the thicknesses of the respective areas according to the average sizes of the dielectric grains is not particularly limited, and detailed descriptions thereof will be made later.

Meanwhile, the average thickness of the first and second internal electrodes 21 and 22 after sintering is not particularly limited as long as capacitance can be formed thereby, and, for example, may be 0.6 μm or less.

The average thickness of the first and second internal electrodes 21 and 22 may be measured from the image obtained by scanning the cross section of the ceramic body 10 in the length direction using a scanning electron microscope (SEM), as shown in FIG. 2.

For example, as shown in FIG. 2, with respect to an internal electrode extracted from the image obtained by scanning the cross-section of the ceramic body 10 in the length-thickness (L-T) direction, cut in the central portion of the ceramic body 10 in the width (W) direction thereof, the average thickness thereof may be obtained by measuring thicknesses thereof at 30 equidistant points in the length direction thereof, and then averaging the measured thicknesses.

The thicknesses at 30 equidistant points may be measured in a capacitance forming part referring to an area in which the first and second internal electrodes 21 and 22 overlap each other.

In addition, when this measurement for obtaining the average thickness is extensively performed on ten or more internal electrodes and then an average measurement value is calculated, the average thickness of the internal electrodes may be more generalized.

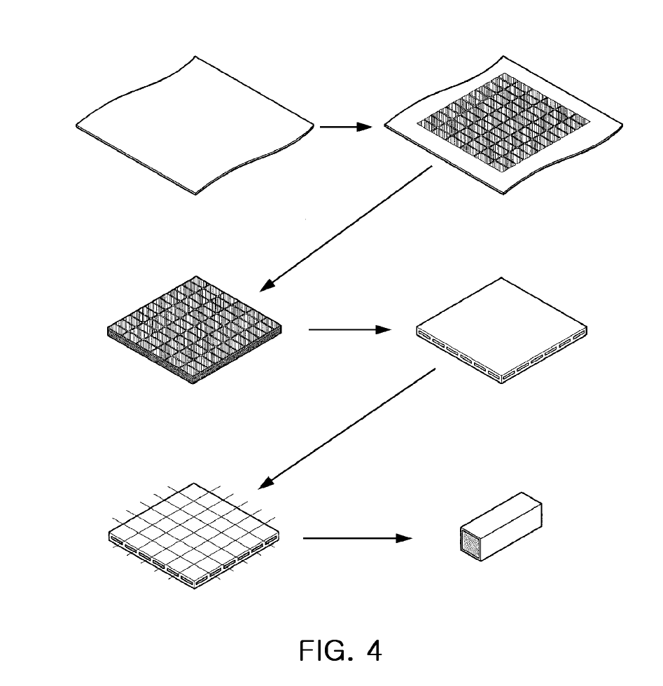

FIG. 4 is a view illustrating a process of manufacturing a multilayer ceramic capacitor according to another embodiment of the present invention.

Referring to FIG. 4, a method of manufacturing a multilayer ceramic electronic component according to another embodiment of the present invention may include: preparing ceramic green sheets by using a slurry containing a ceramic powder; forming internal electrode patterns on the ceramic green sheets, respectively, by using a conductive metal paste; forming a ceramic body including a dielectric layer by laminating the ceramic green sheets; and forming first and second external electrodes on external surfaces of the ceramic body, the first and second external electrodes being electrically connected to the first and second internal electrodes.

In addition, in the method of manufacturing a multilayer ceramic electronic component according to this embodiment of the present invention, when the dielectric layer is divided into three areas in a thickness direction of the ceramic body, an average size of dielectric grains in a middle area of the three areas may be different from that of dielectric grains in upper and lower areas thereof, and when T1 denotes a thickness of the dielectric layer, T2 denotes a thickness of the middle area, and T3 and T4 denote thicknesses of the upper and lower areas adjacent to the first and second internal electrodes, T2≧0.45T1 and T3+T4≦0.55T1 may be satisfied.

Hereinafter, the method of manufacturing a multilayer ceramic electronic component according to the embodiment of the present invention will be described in detail, but descriptions of the same characteristics as the multilayer ceramic electronic component according to the above-described embodiment of the present invention will be omitted in order to avoid repeated explanations.

A method of manufacturing the multilayer ceramic electronic component having the following features is not particularly limited: when the dielectric layer is divided into three areas in the thickness direction of the ceramic body, an average size of dielectric grains in the middle area of the three areas is different from that of dielectric grains in the upper and lower areas thereof, and when T1 denotes the thickness of the dielectric layer, T2 denotes the thickness of the middle area, and T3 and T4 denote the thicknesses of the upper and lower areas adjacent to the first and second internal electrodes, T2≧0.45T1 and T3+T4≦0.55T1 are satisfied.

For example, a method for variably controlling the average sizes of dielectric grains in areas of a single dielectric layer and controlling the thicknesses of the respective areas according to the average sizes of dielectric grains may be used to prepare ceramic green sheets separately.

Specifically, in the preparing of the ceramic green sheets by using a slurry containing a ceramic powder, slurries respectively containing ceramic powders having different average sizes are separately prepared, and then the ceramic green sheets are prepared therewith.

In this case, a slurry containing a ceramic powder having a relatively small average grain size and a slurry containing a ceramic powder having a relatively large average grain size are sequentially coated on a single ceramic green sheet, so that the average size of dielectric grains may be variably controlled in respective areas of the dielectric layer.

Alternatively, a slurry containing a ceramic powder having a relatively small average grain size and a slurry containing a ceramic powder having a relatively large average grain size may be separately used to prepare individual ceramic green sheets, and the ceramic green sheets are then bonded to one another.

In another method, after ceramic green sheets are prepared, slurries respectively containing ceramic powders having relatively different average grain sizes may be coated on each of the ceramic green sheets.

Alternatively, slurries respectively containing ceramic powders having relatively different average grain sizes may be coated on ceramic green sheets on which internal electrode patterns are formed by using a conductive metal paste, or ceramic green sheets manufactured by using slurries respectively containing ceramic powders having relatively different average grain sizes may be bonded to each other.

The various foregoing methods may be used alone or a combination of two or more methods thereof may be simultaneously used, so as to variably control the average sizes of the dielectric grains for the respective areas in a single dielectric layer and control the thicknesses of the respective areas according to the average sizes of dielectric grains, but the invention is not limited thereto.

The number of laminated ceramic green sheets is not particularly limited, and may be, for example, 400 or more in order to manufacture a high capacitance multilayer ceramic electronic component.

In the case in which the number of laminated layers is below 400, the dielectric layers and the internal electrodes are relatively thick, and thus, there may be no problems with continuity of the internal electrodes and withstand voltage characteristics.

That is, it is only in the case in which 400 layers or more are laminated that the dielectric layers become thin, and thus, there may be problematic in terms of the continuity of the internal electrodes, resulting in deteriorated withstand voltage characteristics.

The conductive metal paste may contain at least one selected from the group consisting of nickel (Ni), copper (Cu), palladium (Pd), and a palladium-silver (Pd—Ag) alloy, but is not particularly limited thereto.

Hereafter, the present invention will be described in detail with reference to examples, but is not limited thereto.

In inventive examples, a test was performed on each multilayer ceramic capacitor including a dielectric layer 1 having an average thickness of 0.6 μm or less, in order to evaluate improvements in reliability according to the average sizes of dielectric grains in a middle area and upper and lower areas of the dielectric layer and the thicknesses of the respective areas when the dielectric layer is divided into the three areas in the thickness direction of the ceramic body.

Each multilayer ceramic capacitor according to the inventive examples was manufactured as follows.

First, a slurry containing a powder of barium titanate (BaTiO₃) or the like, having an average grain size of 0.1 μm, was coated on carrier films, followed by drying, to thereby prepare a plurality of ceramic green sheets having a thickness of 1.05 μm or 0.95 μm.

Next, a conductive paste for internal electrodes was prepared by using 50 wt % of a nickel powder, an organic binder, a dispersant, an organic solvent, or the like.

The conductive paste for internal electrodes was coated on the ceramic green sheets by a screen printing method, to thereby form internal electrodes, and then the resulting structures were laminated in amounts of 400 to 500 layers to thereby manufacture a laminate.

After that, compressing and cutting were performed to produce 1005-standard sized chips, and each chip was sintered at a temperature of 1050° C. to 1200° C. under a reducing atmosphere of H₂ of 0.1% or less.

Next, an external electrode forming process, a plating process, and the like were performed to manufacture the multilayer ceramic capacitor.

According to comparative examples, when the dielectric layer was divided into three areas in the thickness direction of the ceramic body, the average sizes of dielectric grains in a middle area and upper and lower areas of the dielectric layer and the thicknesses of the respective areas were different from the ranges thereof in the inventive examples or were equal to general ranges.

In addition, the thicknesses of the middle area and the upper and lower areas of the dielectric layer were measured in a capacitance forming part, on a cross-section of the ceramic body 10 in a length-thickness (L-T) direction, cut in a central portion of the ceramic body 10 in a width (W) direction thereof.

In order to measure the thicknesses of the middle area and the upper and lower areas of the dielectric layer, the thicknesses thereof were measured from an image obtained by scanning ten extracted dielectric layers, using a scanning electron microscope (SEM).

The average size of the dielectric grains in each of the middle area and the upper and lower areas of the dielectric layer was measured by analyzing the image of the extracted dielectric layers using a scanning electron microscope (SEM).

Specifically, the average size of dielectric grains in each of the areas of the dielectric layer was measured by using grain size measurement software supporting an average grain size standard measurement method defined by the American Society for Testing and Materials (ASTM) E112 standard.

Table 1 below shows breakdown voltage (BDV) values and mean time to failure (MTTF) values according to the thicknesses of the middle area and the upper and lower areas of the dielectric layer.

Breakdown voltage (BDV) refers to a voltage in which dielectric breakdown occurs in a dielectric material or an insulator, and the mean time to failure (MTTF) refers to a mean time to failure of irrepairable apparatuses or components. They are measurement factors for evaluating reliability of electronic components.

The measurement of the breakdown voltage (BDV) and the mean time to failure (MTTF) is not particularly limited, and performed by general measurement methods.

TABLE 1

| Sample | T2 | T3 | T4 | BDV (V) | MTTF (hr) |
|---|---|---|---|---|---|
| 1* | T1 | 0 | 0 | 43 | 5.2 |
| 2* | 0.50 T1 | 0.50 T1 | 0 | 55 | 7.3 |
| 3* | 0.70 T1 | 0.30 T1 | 0 | 54 | 7.0 |
| 4* | 0.85 T1 | 0.15 T1 | 0 | 49 | 5.6 |
| 5 | 0.50 T1 | 0.25 T1 | 0.25 T1 | 69 | 9.5 |
| 6 | 0.70 T1 | 0.15 T1 | 0.15 T1 | 62 | 8.0 |
| 7 | 0.80 T1 | 0.10 T1 | 0.10 T1 | 63 | 8.4 |

T1: Thickness of dielectric layer
T2: Thickness of middle area in dielectric layer
T3: Thickness of upper area in dielectric layer
T4: Thickness of lower area in dielectric layer
*Comparative example

Referring to Table 1, it can be seen that Sample 1 was manufactured by the related art method, and in the case in which the average sizes of dielectric grains were equal to each other within the dielectric layer, the breakdown voltage (BDV) and the mean time to failure (MTTF) were low, resulting in deteriorated reliability.

In addition, it can be seen that in Samples 2 to 4 in which the dielectric layer was divided into two areas, the breakdown voltage (BDV) and the mean time to failure (MTTF) were increased as compared with the case manufactured by the related art method.

However, it was determined that Samples 2 to 4 did not meet the levels of breakdown voltage (BDV) and mean time to failure (MTTF) for securing excellent reliability in a high capacitance multilayer ceramic capacitor.

It can be seen that Samples 5 to 7 are cases where, when the dielectric layer was divided into three areas in the thickness direction of the ceramic body, the average sizes of dielectric grains in each of the middle area and the upper and lower areas and the thicknesses of the respective areas were within the numerical ranges of the present invention, and measurement values of the breakdown voltage (BDV) and the mean time to failure (MTTF) were relatively high.

Therefore, it can be seen that the multilayer ceramic capacitor according to the embodiment of the present invention realized high capacitance and had high breakdown voltage (BDV) and mean time to failure (MTTF) and thus had excellent reliability.

As set forth above, according to embodiments of the present invention, there can be provided a large-capacity multilayer ceramic electronic component capable of realizing high capacitance and having excellent accelerated lifespan performance, withstand voltage characteristics.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic component, comprising:
a ceramic body including a dielectric layer;
first and second internal electrodes disposed to face each other with the dielectric layer interposed therebetween within the ceramic body; and
first and second external electrodes formed on external surfaces of the ceramic body and electrically connected to the first and second internal electrodes,
wherein, when the dielectric layer is divided into three areas in a thickness direction of the ceramic body, an average size of dielectric grains in a middle area of the three areas is different from that of dielectric grains in upper and lower areas thereof, and
when T1 denotes a thickness of the dielectric layer, T2 denotes a thickness of the middle area, and T3 and T4 denote thicknesses of the upper and lower areas adjacent to the first and second internal electrodes, T2≧0.45T1 and T3+T4≦0.55T1 are satisfied.

2. The multilayer ceramic electronic component of claim 1, wherein, when the average size of the dielectric grains in the middle area is denoted by G1 and the average size of the dielectric grains in the upper and lower areas is denoted by G2, G1≧1.5×G2 is satisfied.

3. The multilayer ceramic electronic component of claim 1, wherein the dielectric layer has an average thickness of 0.6 μm or less.

4. The multilayer ceramic electronic component of claim 1, wherein the first and second internal electrodes have an average thickness of 0.6 μm or less.

5. The multilayer ceramic electronic component of claim 1, wherein the first and second internal electrodes include at least one selected from the group consisting of nickel (Ni), copper (Cu), palladium (Pd), and a palladium-silver (Pd—Ag) alloy.

6. A method of manufacturing a multilayer ceramic electronic component, the method comprising:
preparing ceramic green sheets by using a slurry containing a ceramic powder;
forming internal electrode patterns on the ceramic green sheets by using a conductive metal paste;
forming a ceramic body including a dielectric layer by laminating the ceramic green sheets; and
forming first and second external electrodes on external surfaces of the ceramic body, the first and second external electrodes being electrically connected to the first and second internal electrodes,
wherein, when the dielectric layer is divided into three areas in a thickness direction of the ceramic body, an average size of dielectric grains in a middle area of the three areas is different from that of dielectric grains in upper and lower areas thereof, and
when T1 denotes a thickness of the dielectric layer, T2 denotes a thickness of the middle area, and T3 and T4 denote thicknesses of the upper and lower areas adjacent to the first and second internal electrodes, T2≧0.45T1 and T3+T4≦0.55T1 are satisfied.

7. The method of claim 6, wherein, when the average size of the dielectric grains in the middle area is denoted by G1 and the average size of the dielectric grains in the upper and lower areas is denoted by G2, G1≧1.5×G2 is satisfied.

8. The method of claim 6, wherein the dielectric layer has an average thickness of 0.6 μm or less.

9. The method of claim 6, wherein the first and second internal electrodes have an average thickness of 0.6 μm or less.

10. The method of claim 6, wherein the number of laminated ceramic green sheets is 400 or more.

11. The method of claim 6, wherein the conductive metal paste includes at least one selected from the group consisting of nickel (Ni), copper (Cu), palladium (Pd), and a palladium-silver (Pd—Ag) alloy.
